(19) United States
(12) Patent Application Publication
(10) Pub. No.: US 2013/0120428 A1
(43) Pub. Date: May 16, 2013

(54) Mobile Projector with Position Dependent Display

(71) Applicants: Mark O. Freeman, Snohomish, WA (US); George Thomas Valliath, Winnetka, IL (US); Jari Honkanen, Monroe, WA (US); David Lashmet, Bainbridge Island, WA (US)

(72) Inventors: Mark O. Freeman, Snohomish, WA (US); George Thomas Valliath, Winnetka, IL (US); Jari Honkanen, Monroe, WA (US); David Lashmet, Bainbridge Island, WA (US)

(73) Assignee: MICROVISION, INC., Redmond, WA (US)

(21) Appl. No.: 13/293,348

(22) Filed: Nov. 10, 2011

(51) Int. Cl. G09G 5/02; G09G 5/00; G02B 26/10

(52) U.S. Cl. 345/589; 359/197.1; 359/212.1; 345/660; 345/649

(57) ABSTRACT

A projection apparatus memorizes settings as a function of location, orientation, elevation, or any combination. The projection apparatus recalls the settings when the location, orientation, elevation, or combination of the projection apparatus matches memorized values. Memorized settings may include projector settings, image source settings, audio output settings, audio source settings, and the like.

### FIELD

The present invention relates generally to projection systems, and more specifically to display settings within projection systems.

### BACKGROUND

Scanning projectors typically scan a light beam in a raster pattern to project an image made up of pixels that lie on the scan trajectory of the raster pattern. The size of the display produced by scanning projectors is typically a function of the distance between the projector and the display surface, as well as the vertical and horizontal scan angles of the raster pattern.

### BRIEF DESCRIPTION OF THE DRAWINGS

FIG. 1 shows a block diagram of a mobile device with a position dependent projection display in accordance with various embodiments of the present invention;

FIG. 2 shows a perspective view of a mobile device with a projector in accordance with various embodiments of the present invention;

FIGS. 3A and 3B show example display settings as a function of projector orientations;

FIG. 4 shows example orientations in accordance with various embodiments of the present invention;

FIG. 5 shows memorized settings as a function of orientation in accordance with various embodiments of the present invention;

FIG. 6 shows example locations in accordance with various embodiments of the present invention;

FIG. 7 shows memorized settings as a function of location in accordance with various embodiments of the present invention;

FIG. 8 shows memorized setting as a function of location and position in accordance with various embodiments of the present invention;

FIG. 9 shows a dynamic scan angle projection apparatus in accordance with various embodiments of the present invention;

FIG. 10 shows a plan view of a microelectromechanical system (MEMS) device with a scanning mirror;

FIG. 11 shows deflection waveforms resulting from a linear vertical trajectory and a sinusoidal horizontal trajectory;

FIG. 12 shows an example dynamic scan angle modification with a constant frame rate;

FIG. 13 shows an example dynamic scan angle modification with an increased frame rate;

FIG. 14 shows projected images resulting from scan angle reductions with a fixed aspect ratio in accordance with various embodiments of the present invention;

FIG. 15 shows projected images resulting from scan angle reductions with distortion in accordance with various embodiments of the present invention;

FIG. 16 shows projected images resulting from scan angle reductions without distortion in accordance with various embodiments of the present invention;

FIG. 17 shows projected images resulting from scan angle reductions with panning and zooming in accordance with various embodiments of the present invention;

FIG. 18 shows a flow diagram of a method in accordance with various embodiments of the present invention.

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

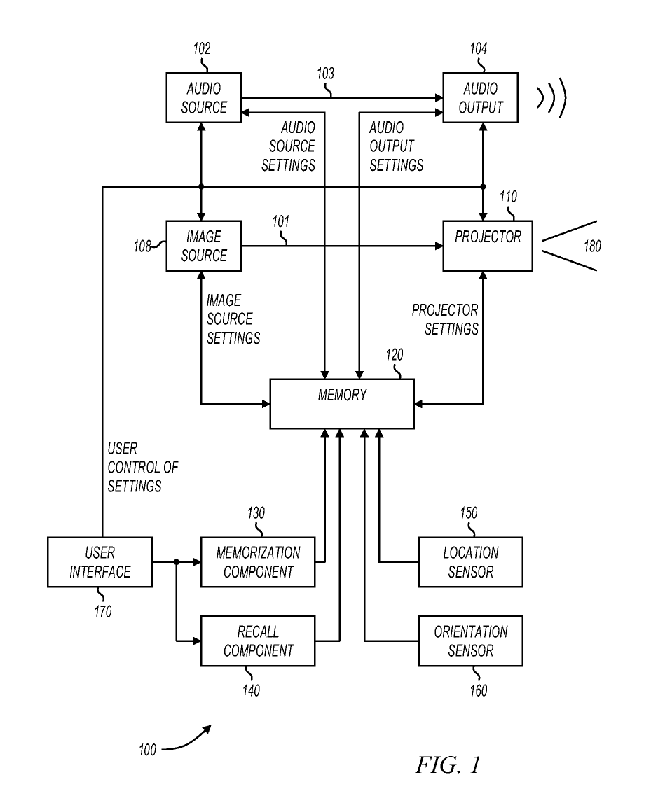

FIG. 1 shows a block diagram of a mobile device with a position dependent projection display in accordance with various embodiments of the present invention. Mobile device 100 includes projector 110 and image source 108. In some embodiments, projector 110 includes a laser scanning projection device, and in other embodiments, projector 110 includes a panel based projection device such as a liquid crystal on silicon (LCOS) device or a device with one or more mirrors per pixel. Image source 108 may be any type of device capable of providing data to be displayed by projector 110. For example, in some embodiments, image source 108 is an internet connection that provides image data in response to a uniform resource locator (URL). Also for example, in some embodiments, image source 108 may be a connector that accepts video data or may be a memory device with stored data that represents still images or videos. Further, in some embodiments, image source 108 represents one or more programs that source image data. For example, image source 108 may be a web browser, a media player, or any other program capable of sourcing image data. Still further, in some embodiments, image source 108 may include a multiplexer that selects from multiple different data sources.

In operation, projector 110 receives display data on node 101 from image source 108 and displays a projected image at 180. As described further below, projector 110 and image source 108 may have settings that are modified by a user, and that may be memorized as a function of position or orientation of mobile device 100. The settings may then be recalled when mobile device 100 is once again at the same location or orientation. As described further below, an orientation of mobile device 100 may be the direction that the device is pointing. In some embodiments, mobile device 100 allows a user to stand at one location while projecting onto various surfaces around him with the content and settings of projector 110 changing according to stored information for each surface he points the projector at. For example, projector 110 may show a first document each time the user projects onto the wall in front of him, a second document each time he projects onto the wall beside him, and a video each time he projects onto a table, each with their own scan angle settings. This allows a user to set up a multi-surface presentation, perhaps in advance of an audience arriving.

Mobile device 100 may also include an audio output device 104 and audio source 102. In some embodiments, audio output device 104 is a speaker, and in other embodiments, audio output device 104 is a connector that allows another audio component to be connected. Audio source 102 may be any type of device capable of providing data representing audio. For example, in some embodiments, audio source 102 is coupled to image source 108 and receives audio data from the same source as the image data on node 101.

In operation, audio output device 104 receives audio data on node 103 from audio source 102. As described further below, audio output device 104 and audio source 102 may have settings that are modified by a user, and that may be memorized as a function of position or orientation of mobile device 100. The settings may then be recalled when mobile device 100 is once again at the same location or orientation.

Mobile device 100 also includes user interface 170, memory 120, memorization component 130, recall component 140, location sensor 150, and orientation sensor 160. User interface 170 may be any type of interface that allows a user to interact with mobile device 100. For example, user interface 170 may include one or more buttons, a keypad, a touchscreen, or the like. User interface 170 may also include feedback devices such as audio or haptic devices.

In operation, user interface 170 allows a user to control settings of projector 110, image source 108, audio output device 104, audio source 102, and possibly other devices as well. Example projector settings may include the size, aspect ratio, or brightness of displayed image 180. In some embodiments, projector settings may also include crop, zoom, and pan settings. Example image source settings may include the source of image data. For example, data may be sourced from a particular URL or from an internal data source. Example audio output settings may include the volume and/or equalization settings for audio output device 104. Example audio source settings may include the source of the audio data. For example, the audio source may be from the same URL as image data, or may be from an internal source.

Location sensor 150 senses the location of mobile device 100. For example, in some embodiments, location sensor 150 includes a global positioning system (GPS) receiver, and in other embodiments, location sensor 150 includes a mobile phone receiver that can determine location based on cell site locations. In some embodiments, location sensor 150 can sense altitude as well as the location on the earth's surface. Location sensor 150 may include any type of sensing device without departing from scope of the present invention.

Orientation sensor 160 senses the orientation of mobile device 100. For example, in some embodiments, orientation sensor 160 includes a compass and/or an accelerometer. In these embodiments, orientation sensor 160 may be able to determine which direction projector 110 is pointing as well as any elevation angle of mobile device 100. Orientation sensor 160 may include any type of sensing device without departing from scope of the present invention.

Memory 120 is any type of device capable of storing settings as a function of a positional reference frame. As used herein, the term “positional reference frame” refers to any location or orientation or combination thereof. In some embodiments, memory 120 is a semiconductor memory device such as FLASH memory, and in other embodiments, memory 120 is a magnetic device such as a magnetic disk. Any type of storage medium may be used for memory 120 without departing from the scope of the present invention.

Memorization component 130 functions to store settings in memory 120. For example, memorization component 130 may store projector settings, image source settings, audio output settings and audio source settings in memory 120. Memorization component 130 may also store a location provided by location sensor 150 and may also store an orientation provided by orientation sensor 160. In some embodiments, memorization component 130 stores the current settings and the current positional reference frame.

In some embodiments, memorization component 130 is implemented in digital hardware. For example, in some embodiments, memorization component 130 may be implemented as an application specific integrated circuit (ASIC). In other embodiments, memorization component 130 is implemented in a combination of hardware and software. For example, in some embodiments, memorization component 130 may be implemented by a microprocessor that executes instructions.

Recall component 140 functions to recall settings from memory 120. For example, recall component 140 may recall previously stored projector settings, image source settings, audio output settings and audio source settings from memory 120. In some embodiments, recall component 140 may recall settings when a positional reference frame is satisfied. For example, when a current location and/or orientation as sensed by location sensor 150 and/or orientation sensor 160 matches a stored positional reference frame, recall component 140 recalls settings associated with that positional reference frame and applies the settings to one or more of projector 110, image source 108, audio output device 104, and audio source 102.

In some embodiments, recall component 140 is implemented in digital hardware. For example, in some embodiments, recall component 140 may be implemented as an application specific integrated circuit (ASIC). In other embodiments, recall component 140 is implemented in a combination of hardware and software. For example, in some embodiments, recall component 140 may be implemented by a microprocessor that executes instructions.

In operation of mobile device 100, a user interacting with user interface 170 may modify current audio and/or video settings. For example, a user may modify projector settings, image source settings, audio output settings, and audio source settings. When the user presses a button, selects a menu item, or otherwise interacts with user interface 170, memorization component 130 stores one or more of the current settings along with the current positional reference frame. This process may be repeated for any number of positional reference frames. For example, a user may store different settings when projecting on different walls in the same room, or may store different settings when projecting in different rooms. The user may then put mobile device 100 into a recall mode in which mobile device 100 recalls and applies settings based on the current positional reference frame. For example, when mobile device is pointed at a first wall in a room, a first set of settings may be recalled and applied to mobile device 100. When the mobile device is pointed at a second wall in the room, a second set of settings may be recalled and applied to mobile device 100.

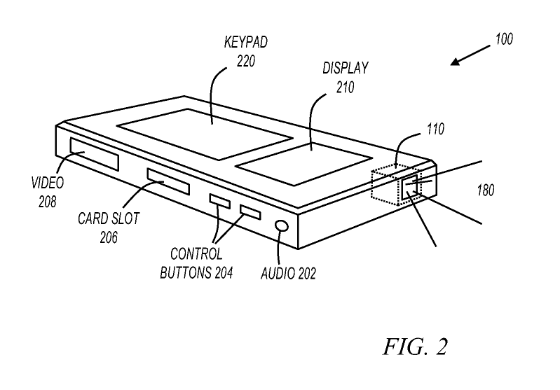

FIG. 2 shows a perspective view of a mobile device with a projector in accordance with various embodiments of the present invention. Mobile device 100 may be a hand held projection device with or without communications ability. For example, in some embodiments, mobile device 100 may be a handheld projector with a position dependent projection display with little or no other capabilities. Also for example, in some embodiments, mobile device 100 may be a device usable for communications, including for example, a cellular phone, a smart phone, a personal digital assistant (PDA), a global positioning system (GPS) receiver, or the like. Further, mobile device 100 may be connected to a larger network via a wireless (e.g., WiMax) or cellular connection, or this device can accept data messages or video content via an unregulated spectrum (e.g., WiFi) connection.

Mobile device 100 includes projector 110 to create an image with light at 180. Mobile device 100 also includes many other types of circuitry; however, they are intentionally omitted from FIG. 2 for clarity.

Mobile device 100 includes display 210, keypad 220, audio port 202, control buttons 204, card slot 206, and audio/video (A/V) port 208. None of these elements are essential. For example, mobile device 100 may only include projector 110 and display 210 without any of keypad 220, audio port 202, control buttons 204, card slot 206, or A/V port 208. Some embodiments include a subset of these elements. For example, an accessory projector product may include projector 110, control buttons 204 and A/V port 208. Display 210, keypad 220, and control buttons 204 are examples of devices that may be included in user interface 170 (FIG. 1).

Display 210 may be any type of display. For example, in some embodiments, display 210 includes a liquid crystal display (LCD) screen. Display 210 may always display the same content projected at 180 or different content. For example, an accessory projector product may always display the same content, whereas a mobile phone embodiment may project one type of content at 180 while displaying different content on display 210. Keypad 220 may be a phone keypad or any other type of keypad. In some embodiments, keypad 220 and display 210 are combined into one touchscreen device.

A/V port 208 accepts and/or transmits video and/or audio signals. For example, A/V port 208 may be a digital port that accepts a cable suitable to carry digital audio and video data, such as a high definition media interface (HDMI) port. Further, A/V port 208 may include RCA jacks to accept composite inputs. Still further, A/V port 208 may include a VGA connector to accept analog video signals. In some embodiments, mobile device 100 may be tethered to an external signal source through A/V port 208, and mobile device 100 may project content accepted through A/V port 208 when image source 108 (FIG. 1) is set to receive external content. In other embodiments, mobile device 100 may be an originator of content, and A/V port 208 is used to transmit content to a different device.

Audio port 202 is an example of audio output device 104 (FIG. 1). Audio port 202 may be a speaker or may be a connector that provides audio signals. For example, in some embodiments, mobile device 100 is a media player that can store and play audio and video. In these embodiments, the video may be projected at 180 and the audio may be output at audio port 202. In other embodiments, mobile device 100 may be an accessory projector that receives audio and video at A/V port 208. In these embodiments, mobile device 100 may project the video content at 180, and output the audio content at audio port 202.

Mobile device 100 also includes card slot 206. In some embodiments, a memory card inserted in card slot 206 may provide a source for audio to be output at audio port 202 and/or video data to be projected at 180. Card slot 206 may receive any type of solid state memory device, including for example, Multimedia Memory Cards (MMCs), Memory Stick DUOS, secure digital (SD) memory cards, and Smart Media cards. The foregoing list is meant to be exemplary, and not exhaustive.

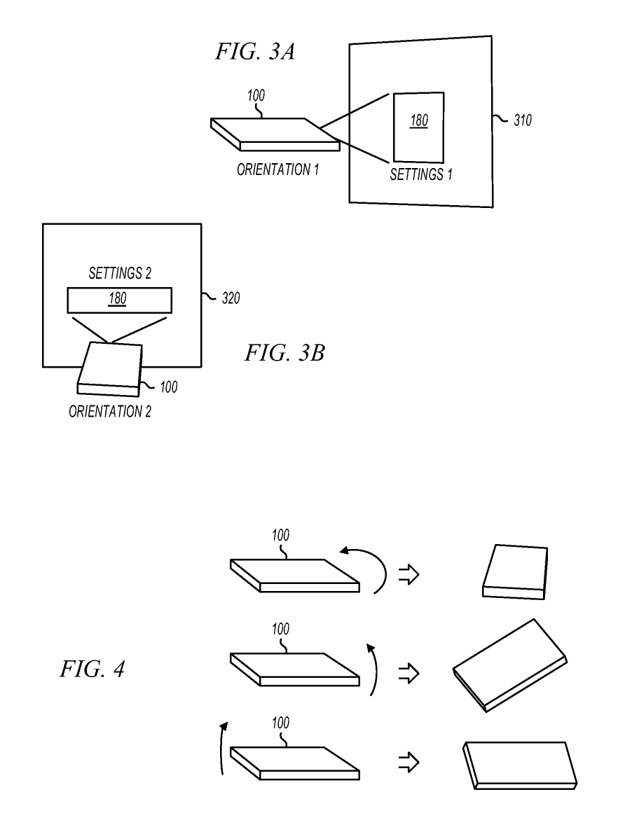

FIGS. 3A and 3B show example display settings as a function of projector orientations. FIG. 3A shows mobile device 100 with a positional reference frame defined by a first orientation. When in this first positional reference frame, mobile device 100 projects image 180 on surface 310 with a first set of projector settings. FIG. 3B shows mobile device 100 with a second positional reference frame defined by a second orientation. When in this second positional reference frame, mobile device 100 projects image 180 on surface 320 with and a second set of projector settings.

In the example of FIGS. 3A and 3B, the second set of projector settings has a different aspect ratio than the first set of projector settings. In some embodiments, the projector settings may also differ in brightness, content, zoom, pan, crop, or any other type of setting. When in the first orientation, the user causes mobile device to memorize the first settings, and when in the second orientation, the user causes the mobile device to memorize the second settings. Thereafter, when the mobile device satisfies the first orientation, the first settings are recalled and applied, and when the mobile device satisfies the second orientation, the second settings are recalled and applied.

FIG. 4 shows example orientations in accordance with various embodiments of the present invention. Any type of orientation may be used when storing or detecting a positional reference frame. For example, pitch, roll, or yaw of mobile device 100 may be modified in any combination to arrive at a different orientation. Any of these orientations may be used as a positional reference frame.

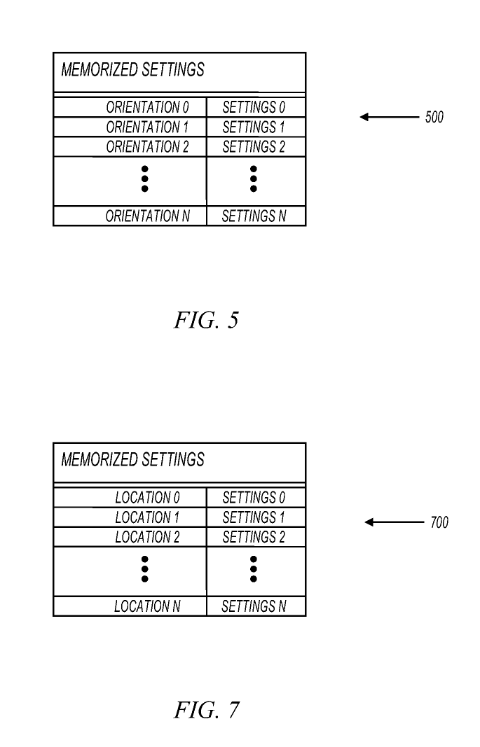

FIG. 5 shows memorized settings as a function of orientation in accordance with various embodiments of the present invention. Memorized settings 500 are an example of the contents of memory 120 (FIG. 1) when positional reference frames are defined by an orientation. The settings in memorized settings 500 may include type of settings for mobile device 100. Examples include, but are not limited to, projector settings, image source settings, audio output settings, and audio source settings. Each of the records in memorized settings 500 may be stored in memory 120 when memorization component 130 stores the current settings and current orientation. After memorized settings 500 have been established, they may be recalled by recall component 140 when the mobile device once again satisfies one of the stored orientations.

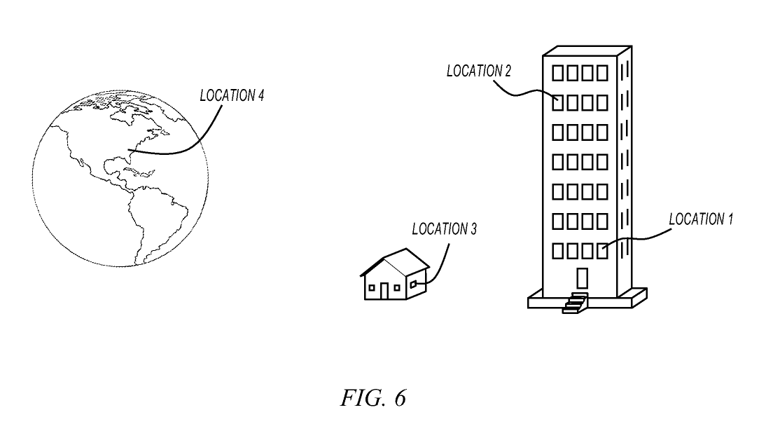

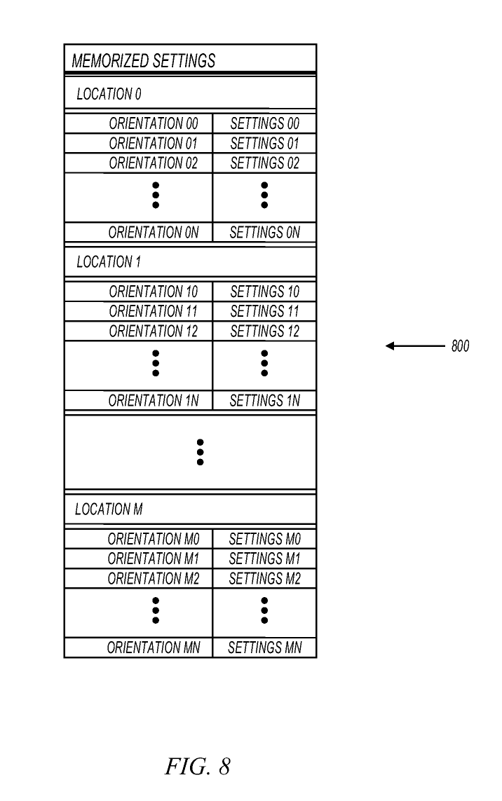

FIG. 6 shows example locations in accordance with various embodiments of the present invention. FIG. 6 shows first and second example locations as different floors and offices within an office building. In some embodiments, when location sensor 150 (FIG. 1) includes a GPS receiver or atmospheric pressure sensor, location information may include altitude. The third example location is a room in a house, and the fourth example location is a spot on the surface of the earth. In some embodiments, the spot on the surface of the earth has very high resolution, and in other embodiments, the spot on the surface of the earth has a somewhat lower resolution. For example, in some embodiments, a GPS receiver may provide location information within a few meters, and in other embodiments, a mobile phone receiver may provide location information within the resolution provided by the spacing of mobile cell sites.

FIG. 7 shows memorized settings as a function of location in accordance with various embodiments of the present invention. Memorized settings 700 are an example of the contents of memory 120 (FIG. 1) when positional reference frames are defined by a location. The settings in memorized settings 700 may include type of settings for mobile device 100. Examples include, but are not limited to, projector settings, image source settings, audio output settings, and audio source settings. Each of the records in memorized settings 700 may be stored in memory 120 when memorization component 130 stores the current settings and current location. After memorized settings 700 have been established, they may be recalled by recall component 140 when the mobile device once again satisfies one of the stored locations.

FIG. 8 shows memorized setting as a function of location and position in accordance with various embodiments of the present invention. Memorized settings 800 may result when mobile device 100 defines positional reference frames by a combination of location and orientation. For example, a first positional reference frame may be defined by location 1 in the office building with an orientation pointing to the west. Also for example, a second positional reference frame may be defined by location 3 in the house with an orientation to the north. Any combination of locations and orientations may be used to define a positional reference frame.

Memorized settings 800 are an example of the contents of memory 120 (FIG. 1) when positional reference frames are defined by combinations of a location and an orientation. The settings in memorized settings 800 may include type of settings for mobile device 100. Examples include, but are not limited to, projector settings, image source settings, audio output settings, and audio source settings. Each of the records in memorized settings 800 may be stored in memory 120 when memorization component 130 stores the current settings and current positional reference frame defined by a combination of location and orientation. After memorized settings 800 have been established, they may be recalled by recall component 140 when the mobile device once again satisfies one of the stored positional reference frames.

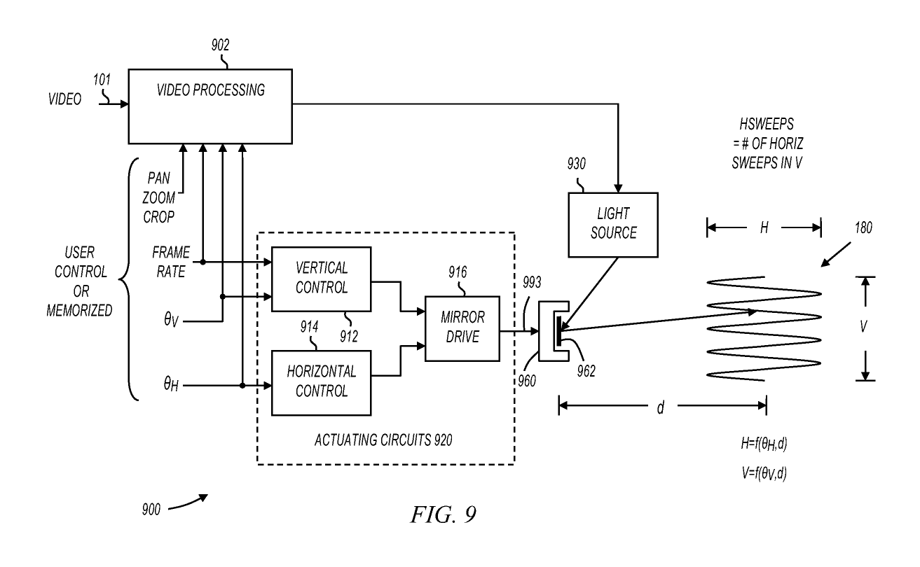

FIG. 9 shows a dynamic scan angle projection apparatus in accordance with various embodiments of the present invention. Apparatus 900 is an example of a projection apparatus that may be utilized as projector 110 (FIGS. 1, 2). Apparatus 900 includes video processing component 902, light source 930, micro-electronic machine (MEMS) device 960 having scanning mirror 962, and actuating circuits 920. Actuating circuits 920 include vertical control component 912, horizontal control component 914, and mirror drive component 916.

In operation, video processing component 902 receives video data on node 101 and produces display pixel data to drive light source 930 when pixels are to be displayed. The video data 101 represents image source data that is typically received with pixel data on a rectilinear grid, but this is not essential. For example, video data 101 may represent a grid of pixels at any resolution (e.g., 640×480, 848×480, 1920×1080). Dynamic scan angle projection apparatus 900 is a scanning projector that scans a raster pattern. The raster pattern does not necessarily align with the rectilinear grid in the image source data, and video processing component 902 operates to produce display pixel data that will be displayed at appropriate points on the raster pattern. For example, in some embodiments, video processing component 902 interpolates vertically and/or horizontally between pixels in the source image data to determine display pixel values along the scan trajectory of the raster pattern.

Light source 930 receives display pixel data and produces light having grayscale values in response thereto. Light source 930 may be monochrome or may include multiple different color light sources. For example, in some embodiments, light source 930 includes red, green, and blue light sources. In these embodiments, video processing component 902 outputs display pixel data corresponding to each of the red, green, and blue light sources. Also for example, light produced by light source 930 may be visible or nonvisible. For example, in some embodiments, one or more sources of light within light source 930 may produce infrared (IR) light.

In some embodiments, light source 930 may include one or more laser light producing devices. For example, in some embodiments, the light source 930 may include laser diodes. In these embodiments, light source 930 also includes driver circuits that accept the display pixel values and produce current signals to drive the laser diodes. The light from light source 930 is directed to mirror 962. In some embodiments, optical elements are included in the light path between light source 930 and mirror 962. For example, dynamic scan angle projection apparatus 900 may include collimating lenses, dichroic mirrors, or any other suitable optical elements.

Scanning mirror 962 deflects on two axes in response to electrical stimuli received on node 993 from actuating circuits 920. While moving on the two axes, scanning mirror 962 reflects light provided by light source 930. The reflected light sweeps a raster pattern and creates a resultant display at 180. The shape of the raster pattern swept by scanning mirror 962 is a function of the mirror movement on its two axes. For example, in some embodiments, scanning mirror 962 sweeps in a first dimension (e.g., vertical dimension) in response to sawtooth wave stimulus, resulting in a substantially linear and unidirectional vertical sweep. Also for example, in some embodiments, scanning mirror 962 sweeps in a second dimension (e.g., horizontal dimension) according to a sinusoidal stimulus, resulting in a substantially sinusoidal horizontal sweep.

MEMS device 960 is an example of a scanning mirror assembly that scans light in two dimensions. In some embodiments the scanning mirror assembly includes a single mirror that scans in two dimensions (e.g., on two axes). Alternatively, in some embodiments, MEMS device 960 may be an assembly that includes two scan mirrors, one which deflects the beam along one axis, and another which deflects the beam along a second axis largely perpendicular to the first axis.

The resultant display has a height (V) and a width (H) that are a function of the distance (d) from scanning mirror 962 to the projection surface, as well as the scan angles of the mirror. As used herein, the term “scan angle” refers to the total angle through which the mirror deflects rather than an instantaneous angular displacement of the mirror. The width (H) is a function of the distance (d) and the horizontal scan angle (θ_{H}). This relationship is shown in FIG. 9 as

H=ƒ(θ_{H}, d) (1)

The height (V) is a function of the distance (d) and the vertical scan angle (θ_{V}). This relationship is shown in FIG. 9 as

V=ƒ(θ_{V}, d) (2)

In various embodiments of the present invention, either or both of the vertical and horizontal scan angles are dynamically modified during operation of the scanning projection apparatus to accomplish various results. Example results include changing the size or aspect ratio of the resultant display, maintaining the size of the resultant display as the distance (d) changes, and maintaining image brightness as the distance and/or aspect ratio changes.

As shown in FIG. 9, horizontal control component 914 receives signal stimulus that represents the horizontal scan angle, and vertical control component 912 receives signal stimulus that represents the vertical scan angle. The scan angle signal stimulus may be provided on multiple signal lines (e.g., dedicated signal lines, or a shared bus) or may be provided on a single signal line (e.g., a serial bus). The scan angle signal stimulus may be provided by user interface 170 (FIG. 1) or by memory 120 (FIG. 1). The manner in which signal stimulus is provided is not a limitation of the present invention.

Horizontal control component 914 and vertical control component 912 receive the scan angle signal stimulus and produce signals to effect actual mirror movement through the specified scan angles. The signals produced by vertical control component 912 and horizontal control component 914 are combined by mirror drive component 916, which drives MEMS device 960 with a composite signal on node 993. In some embodiments that include two scan mirrors, MEMS device 960 is driven directly by signals produced by vertical control component 912 and horizontal control component 914.

The horizontal and vertical scan angles may be controlled manually by the user through the user interface, or by recall when a positional reference frame is detected, or any combination. For example, user controls may be provided to allow a user to modify scan angles. Also for example, scan angles previously stored may be recalled and applied to apparatus 900 when a positional reference frame is satisfied.

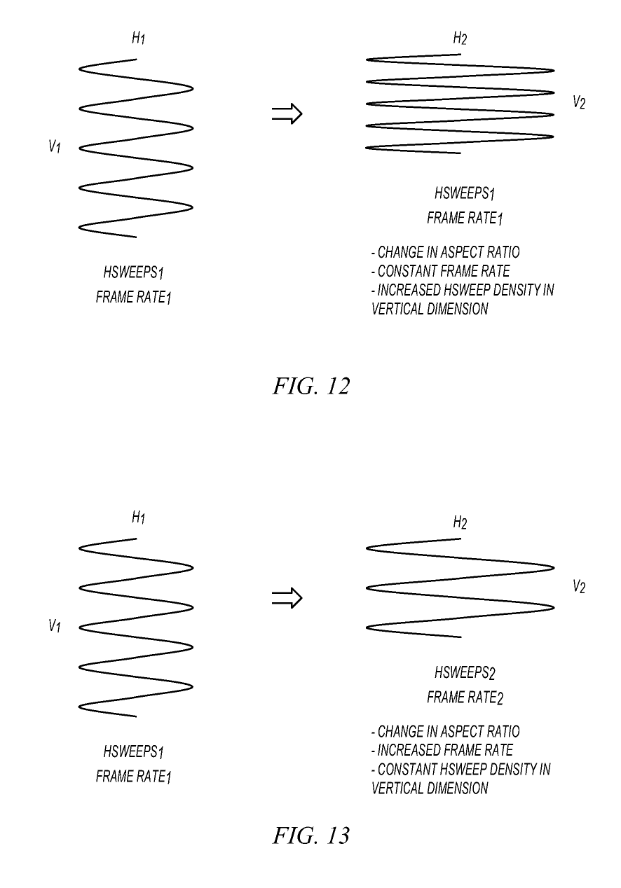

The number of horizontal sweeps per vertical sweep in the raster pattern is referred to herein as HSWEEPS. In some embodiments, HSWEEPS changes as one or both scan angles change, and in other embodiments, HSWEEPs remains constant as one or more scan angles change. For example, if the vertical scan angle is reduced, the spatial density of horizontal sweeps will increase if d and HSWEEPS remain constant. In some embodiments, it may be desirable to modify HSWEEPS to allow for various (or constant) spatial density of horizontal sweeps. This is shown in greater detail in FIGS. 12 and 13.

In some embodiments, the number of horizontal sweeps (HSWEEPS) is related to the frame rate. For example, if the horizontal sweep frequency is fixed (as it is in mechanically resonant systems) then the frame rate and HSWEEPS are inversely related. As shown in FIG. 9, in some embodiments, the frame rate may be modified along with the scan angles. This allows control of the size and aspect ratio of the resultant display, as well HSWEEPS, which affects the spatial density of horizontal sweeps in the resultant display. As used herein, the term “frame rate” refers to the rate at which the raster pattern repeats, and is not necessarily related to a frame rate of any incoming video.

In some embodiments, the frame rate and scan angles are provided to video processing component 902. Video processing component 902 may utilize this information to modify the image to be displayed. For example, video processing component 902 may modify the display contents or the interpolation algorithms based on this information.

In some embodiments, video processing component 902 is responsive to settings beyond the scan angles and frame rate. For example, as shown in FIG. 9, video processing component 902 may be responsive to pan settings, zoom settings, crop settings, and the like.

Although FIG. 9 shows actuating circuits 920 receiving the frame rate and vertical and horizontal scan angles, this is not a limitation of the present invention. For example, in some embodiments, actuating circuits 920 receive signal stimulus that represents HSWEEPS. Further, in some embodiments, actuating circuits 920 receive signal stimulus that represents an aspect ratio rather than scan angles.

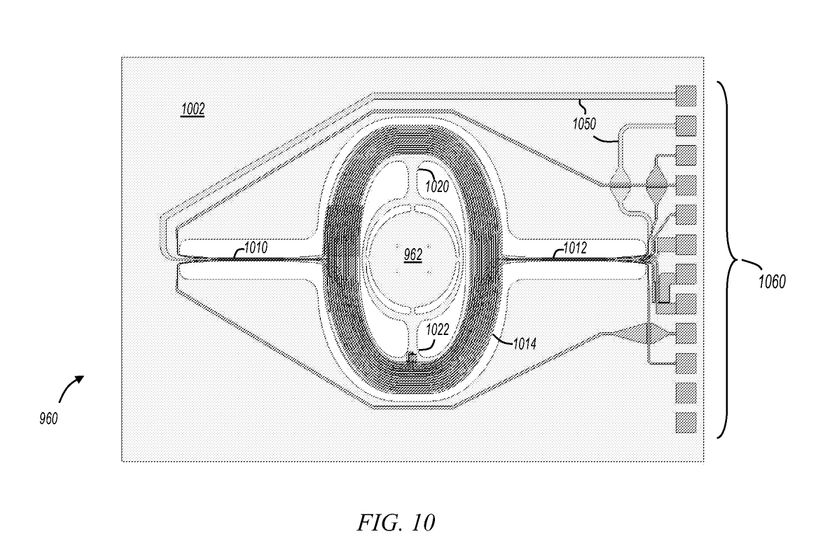

FIG. 10 shows a plan view of a microelectromechanical system (MEMS) device with a scanning mirror. MEMS device 960 includes fixed platform 1002, scanning platform 1014 and scanning mirror 962. Scanning platform 1014 is coupled to fixed platform 1002 by flexures 1010 and 1012, and scanning mirror 962 is coupled to scanning platform 1014 by flexures 1020 and 1022. Scanning platform 1014 has a drive coil connected to drive lines 1050, which are driven by a composite signal provided on node 993 from actuating circuits 920 (FIG. 9). Current driven into drive lines 1050 produces a current in the drive coil. Two of the interconnects 1060 are coupled to drive lines 1050.

In operation, an external magnetic field source (not shown) imposes a magnetic field on the drive coil. The magnetic field imposed on the drive coil by the external magnetic field source has a component in the plane of the coil, and is oriented non-orthogonally with respect to the two drive axes. The in-plane current in the coil windings interacts with the in-plane magnetic field to produce out-of-plane Lorentz forces on the conductors. Since the drive current forms a loop on scanning platform 1014, the current reverses sign across the scan axes. This means the Lorentz forces also reverse sign across the scan axes, resulting in a torque in the plane of and normal to the magnetic field. This combined torque produces responses in the two scan directions depending on the frequency content of the torque.

The long axis of flexures 1010 and 1012 form a pivot axis. Flexures 1010 and 1012 are flexible members that undergo a torsional flexure, thereby allowing scanning platform 1014 to rotate on the pivot axis and have an angular displacement relative to fixed platform 1002. Flexures 1010 and 1012 are not limited to torsional embodiments as shown in FIG. 10. For example, in some embodiments, flexures 1010 and 1012 take on other shapes such as arcs, “S” shapes, or other serpentine shapes. The term “flexure” as used herein refers to any flexible member coupling a scanning platform to another platform (scanning or fixed), and capable of movement that allows the scanning platform to have an angular displacement with respect to the other platform.

Mirror 962 pivots on a first axis formed by flexures 1020 and 1022, and pivots on a second axis formed by flexures 1010 and 1012. The first axis is referred to herein the horizontal axis, and the second axis is referred to herein as the vertical axis. The distinction between vertical and horizontal is somewhat arbitrary, since a rotation of the projection apparatus will cause a rotation of the two axes. Accordingly, the various embodiments of the present invention are not to be limited by the terms “horizontal” and “vertical.”

In some embodiments, scanning mirror 962 scans at a mechanically resonant frequency on the horizontal axis resulting in a sinusoidal horizontal sweep. Further, in some embodiments, scanning mirror 962 scans vertically at a nonresonant frequency, so the vertical scan frequency can be controlled independently.

In various embodiments of the present invention, one or more scan angles of mirror 962 are modified during operation. For example, the horizontal scan angle may be modified, the vertical scan angle may be modified, or both may be modified. Further, in some embodiments, the period of the vertical sweep may be modified to control the frame rate and/or HSWEEPS. The scan angles and periods may be controlled and modified by signal stimulus received on drive lines 1050. This signal stimulus is provided on node 993 by actuating circuits 920 (FIG. 9).

The particular MEMS device embodiment shown in FIG. 10 is provided as an example, and the various embodiments of the invention are not limited to this specific implementation. For example, any scanning mirror capable of sweeping in two dimensions to reflect a light beam in a raster pattern may be incorporated without departing from the scope of the present invention. Also for example, any combination of scanning mirrors (e.g., two mirrors: one for each axis) may be utilized to reflect a light beam in a raster pattern. Further, any type of mirror drive mechanism may be utilized without departing from the scope of the present invention. For example, although MEMS device 960 uses a drive coil on a moving platform with a static magnetic field, other embodiments may include a magnet on a moving platform with drive coil on a fixed platform. Further, the mirror drive mechanism may include an electrostatic drive mechanism. In still further embodiments, a scanning mirror is not employed at all, and a panel based projector is used in its place.

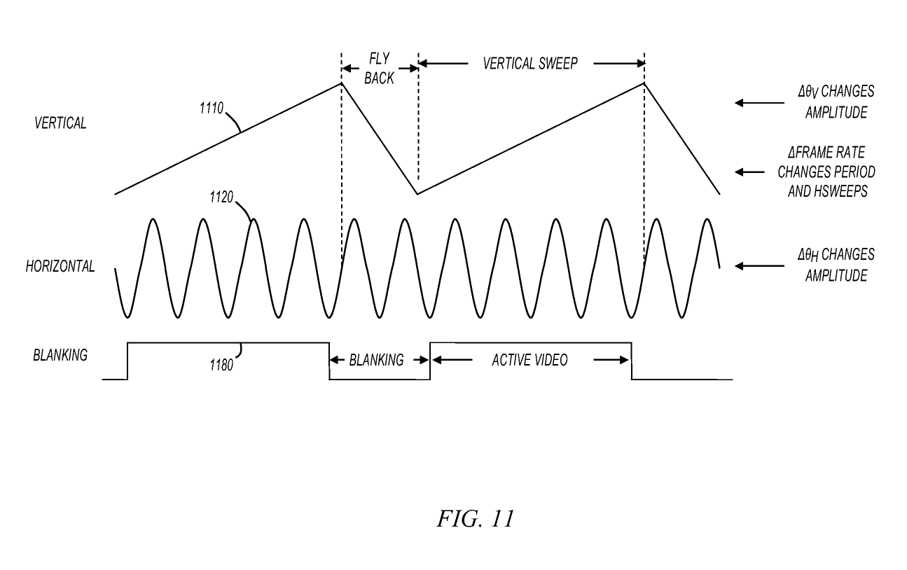

FIG. 11 shows example waveforms suitable for the operation of the dynamic scan angle projection apparatus of FIG. 9. Vertical deflection waveform 1110 is a sawtooth waveform, and horizontal deflection waveform 1120 is a sinusoidal waveform. When mirror 962 is deflected on its vertical and horizontal axes according to the waveforms 1110 and 1120, the scanned beam trajectory shown in the left side of FIGS. 12 and 13 results.

Deflection of mirror 962 according to waveforms 1110 and 1120 may be achieved by driving MEMS device 960 with the appropriate drive signals. In some embodiments, the horizontal deflection frequency is at a resonant frequency of the mirror and a very small excitation at that frequency will result in the desired scan angle. A sawtooth drive signal for the vertical deflection may be derived from a sum of sine waves at various frequencies. The drive signal for the vertical deflection may also be derived from specific points programmed into a waveform generator.

Although a sawtooth drive signal will result in the vertical deflection shown in FIG. 11, other drive signal embodiments exist. For example, in some embodiments, the vertical drive signal may be triangle wave (where subsequent frames are written top to bottom followed by bottom to top alternating each frame) or sinusoidal waveforms.

Sawtooth vertical deflection waveform 1110 includes vertical sweep portions and flyback portions. In some embodiments, pixels are displayed during the vertical sweep portions, and not during the flyback portions. The flyback portions correspond to the beam “flying back” to the top of the image field of view. Blanking waveform 1180 is also shown in FIG. 11. The scanned beam is blanked (no pixels are displayed) during flyback, and is not blanked during the vertical sweep.

For clarity of explanation, FIG. 11 shows only a few horizontal cycles per vertical sweep. In practice, many more horizontal cycles are present. For example, a horizontal resonant frequency of 24.5 kHz and a frame rate of 60 Hz will yield about 408 horizontal cycles per vertical sweep or about 816 horizontal lines. If the flyback time is about 11.9% of the sawtooth period, then there will be approximately 720 horizontal lines of active video.

The amplitude of horizontal deflection waveform 1120 corresponds to the horizontal scan angle. As the amplitude increases, the scan angle also increases. Referring now back to FIG. 9, as θ_{H} increases, actuating circuits 920 provide stimulus to MEMS 960 that causes the amplitude of horizontal deflection waveform 1120 to increase. Stated generally, a change in θ_{H} (Δθ_{H}) results in a change in the amplitude of the horizontal deflection waveform 1120. Similarly, the amplitude of vertical deflection waveform 1110 corresponds to the vertical scan angle. As the amplitude increases, the scan angle also increases. Referring now back to FIG. 9, as θ_{V} increases, actuating circuits 920 provide stimulus to MEMS 960 that causes the amplitude of vertical deflection waveform 1110 to increase. Stated generally, a change in θ_{V} (Δθ_{V}) results in a change in the amplitude of the vertical deflection waveform 1110.

The period of vertical deflection waveform 1110 is related to the frame rate. As the frame rate increases, the period of vertical deflection waveform 1110 decreases. In systems with a fixed horizontal scanning frequency, the number of horizontal sweeps per vertical sweep (HSWEEPS) also changes with the frame rate. Stated generally, a change in frame rate (Δframe rate) results in a change in the period of vertical deflection waveform 1110, and may result in a change in HSWEEPS.

FIG. 12 shows an example dynamic scan angle modification with a constant frame rate. The left side of FIG. 12 shows a resultant display with a width H₁, a height V₁, a frame rate FRAME RATE₁, and a number of horizontal sweeps per vertical sweep HSWEEPS₁. The right side of FIG. 12 shows the resultant display when the width is increased to H₂ and the height is decreased to V₂ while maintaining the same number of horizontal sweeps per vertical sweep and maintaining the same frame rate. Referring now back to FIG. 11, this corresponds to a decrease in the amplitude of vertical deflection waveform 1110, an increase in the amplitude of horizontal deflection waveform 1120, and no change in the period of vertical deflection waveform 1110. Note that the spatial density of horizontal sweeps in the vertical dimension is increased because the vertical scan angle has been decreased while maintaining a constant frame rate.

The dynamic scan angle modification shown in FIG. 12 results from an decrease in θ_{V} and a increase in θ_{H} maintaining the same frame rate. Referring now back to FIG. 9, signal stimulus representing θ_{H} and θ_{V} may be provided to actuating circuits 920 during operation of the projection apparatus to effect the dynamic scan angle modification. The signal stimulus representing θ_{H} and θ_{V} may be provided in any manner and may be the result of automatic or manual control of scan angles.

FIG. 13 shows an example dynamic scan angle modification with an increased frame rate. The example dynamic scan angle modification shown in FIG. 13 modifies the two scan angles θ_{H} and θ_{V} in the same manner as shown in FIG. 12 resulting in the width of the resultant display changing from H₁ to H₂, and resulting in the height of the resultant display changing from V₁to V₂.

The example dynamic scan angle modification of FIG. 13 differs from that of FIG. 12 in that the frame rate is increased from FRAME RATE₁ to FRAME RATE₂. As a result, the number of horizontal sweeps per vertical sweep in the resultant display decreases from HSWEEPS₁ to HSWEEPS₂. In the example of FIG. 12, θ_{V} and the frame rate have been modified to maintain a constant HSWEEP density. In some embodiments, both the θ_{V} and the frame rate are modified without maintaining a constant HSWEEP density.

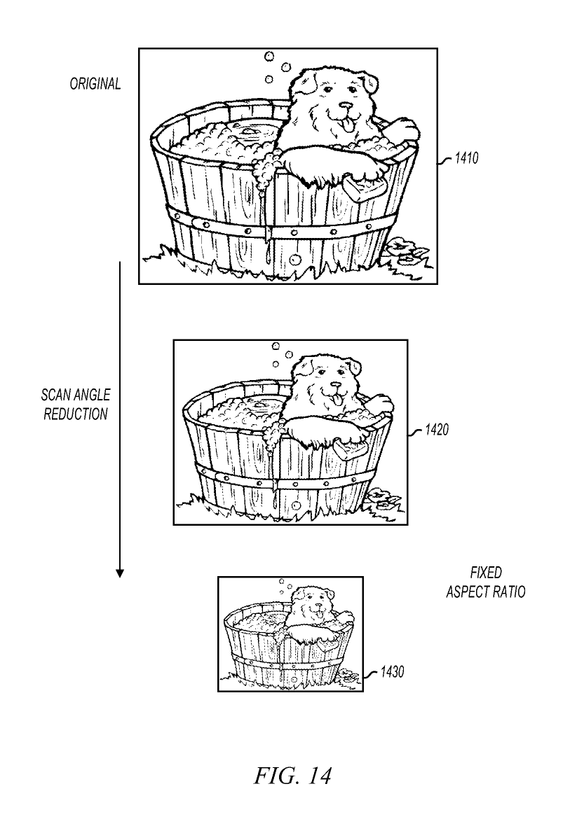

FIG. 14 shows projected images resulting from scan angle reductions with a fixed aspect ratio in accordance with various embodiments of the present invention. Image 1410 represents a full size projected image with maximum scan angles. In some embodiments, a user may modify the size of the image while maintaining a fixed aspect ratio. For example, images 1420 and 1430 represent reduced size projected images with fixed aspect ratios. Brightness settings may also be modified when changing the size of projected images with a fixed aspect ratio.

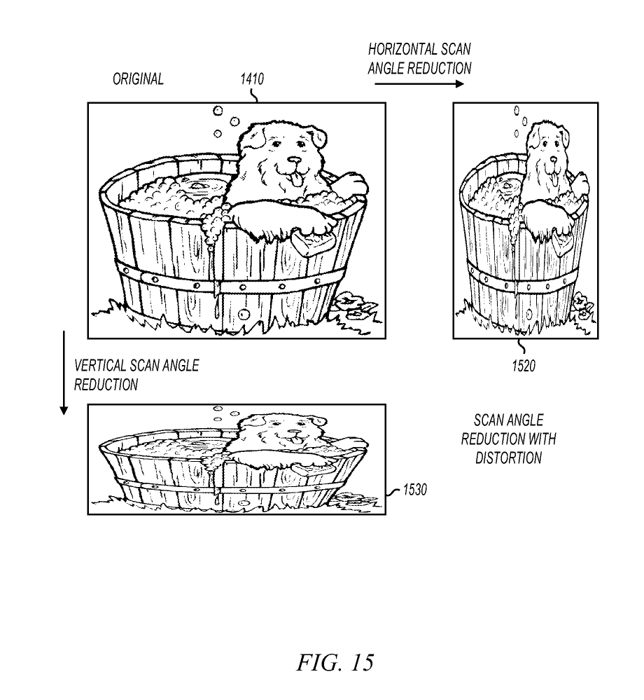

FIG. 15 shows projected images resulting from scan angle reductions with distortion in accordance with various embodiments of the present invention. Image 1410 represents a full size projected image with maximum scan angles. In some embodiments, a user may modify one or both scan angles without maintaining a fixed aspect ratio, and introducing distortion in the image. For example, projected image 1520 results when the horizontal scan angle (θ_{H}) is reduced while the vertical scan angle (θ_{V}) remains constant, and projected 1530 results when the vertical scan angle (θ_{V}) is reduced while the horizontal scan angle (θ_{H}) remains constant. Brightness settings may also be modified when changing the size of projected images without a fixed aspect ratio.

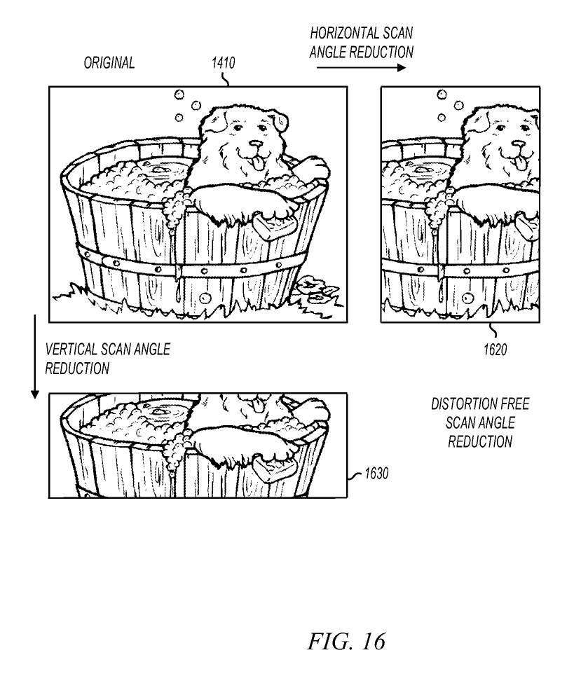

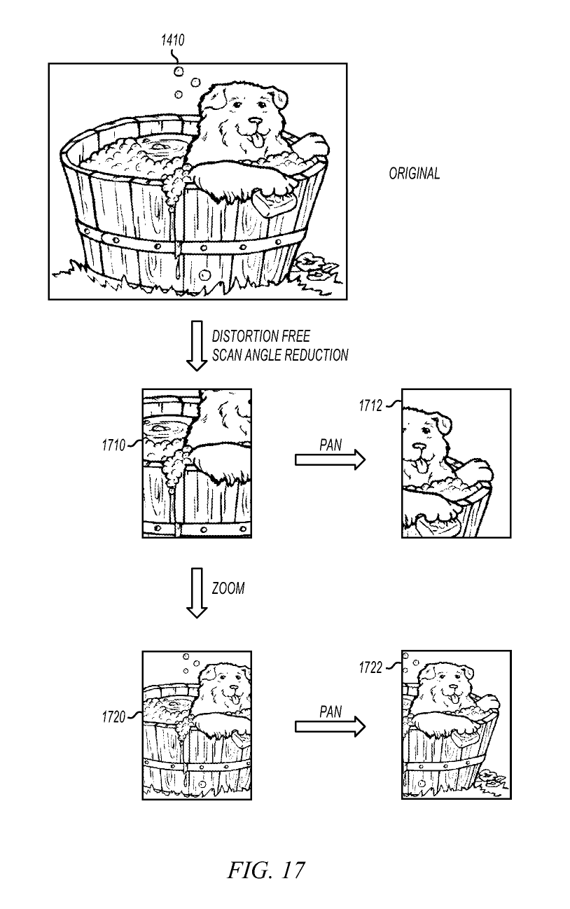

FIG. 16 shows projected images resulting from scan angle reductions without distortion in accordance with various embodiments of the present invention. Image 1410 represents a full size projected image with maximum scan angles. In some embodiments, a user may modify one or both scan angles without maintaining a fixed aspect ratio, but with image cropping to provide a distortion free image. For example, projected image 1620 results when the horizontal scan angle (θ_{H}) is reduced while the vertical scan angle (θ_{V}) remains constant, and projected 1630 results when the vertical scan angle (θ_{V}) is reduced while the horizontal scan angle (θ_{H}) remains constant. In some embodiments, distortion free results are accomplished by modifying the crop setting provided to video processing component 902 (FIG. 9). Brightness settings may also be modified when changing the size of projected images without a fixed aspect ratio.

FIG. 17 shows projected images resulting from scan angle reductions with panning and zooming in accordance with various embodiments of the present invention. Image 1410 represents a full size projected image with maximum scan angles. Image 1710 is obtained by modifying one or more scan angles and crop settings as described with reference to FIG. 16. Image 1712 may be obtained from image 1710 by panning within the original image extents. Image 1720 may be obtained from image 1710 by zooming within the original image, and image 1722 may be obtained from image 1720 by panning within the original image extents. Any of the images shown in FIG. 17 may be obtained by setting the scan angles, crop settings, zoom settings, and pan settings shown in FIG. 9.

All of the projector settings that result in the projected images shown in the previous figures may be set by a user, memorized as a function of positional reference frames, and recalled when positional reference frames are satisfied. Although images 1410, 1420, 1430, 1520, 1530, 1620, 1630, 1710, 1712, 1720, and 1722 are described as resulting from a dynamic scan angle projector having different scan angles, they may also be generated by modifying the display settings of a panel based projector.

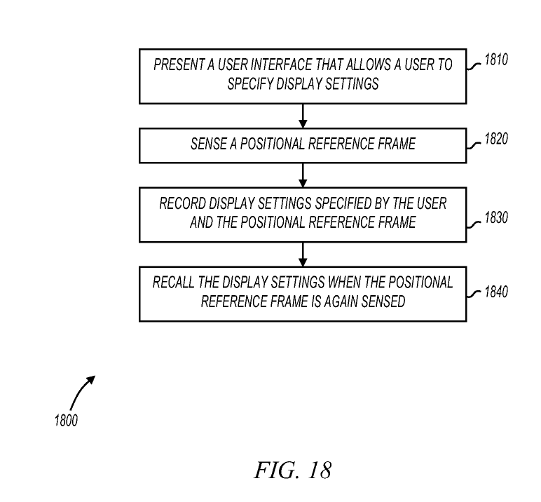

FIG. 18 shows a flow diagram of methods in accordance with various embodiments of the present invention. In some embodiments, method 1800, or portions thereof, is performed by a mobile device, embodiments of which are shown in previous figures. In other embodiments, method 900 is performed by a dynamic scan angle projection apparatus, a series of circuits, or an electronic system. Method 1800 is not limited by the particular type of apparatus performing the method. The various actions in method 1800 may be performed in the order presented, or may be performed in a different order. Further, in some embodiments, some actions listed in FIG. 18 are omitted from method 1800.

Method 1800 is shown beginning with block 1810 when a user is presented with a user interface that allows a user to specify display settings. For example, a user may be able to specify settings such as an aspect ratio, a vertical scan angle, a horizontal scan angle, the number of horizontal sweeps per frame, brightness, distortion correction settings, and the like. The user interface may also allow a user to specify the source of image data. Beside display settings the user interface may also allow a user to specify audio settings, including volume and audio source settings.

At 1820, a positional reference frame is sensed. The positional reference frame may be a function of orientation, location, elevation, or any combination. At 1830, display settings and the positional reference frame are recorded. The actions of 1810, 1820, and 1830 may be repeated any number of times to result in any of memorized settings 500 (FIG. 5), 700 (FIG. 7), or 800 (FIG. 8). Further, in some embodiments, a user may specify transitions, such as morphing the display when the positional reference frame changes from one to another.

At 1840, the display settings are recalled and applied when the positional reference frame is again sensed. This allows different content with different settings to be displayed on different surfaces based on location and/or orientation.

Although the present invention has been described in conjunction with certain embodiments, it is to be understood that modifications and variations may be resorted to without departing from the scope of the invention as those skilled in the art readily understand. Such modifications and variations are considered to be within the scope of the invention and the appended claims.

What is claimed is:

1. An apparatus comprising:
a projector;
a memorization component to memorize at least one projector setting for each of a plurality of positional reference frames; and
a recall component to access a memorized projector setting when the apparatus occupies one of the plurality of positional reference frames.

2. The apparatus of claim 1 wherein the at least one projector setting comprises an aspect ratio of a projected display.

3. The apparatus of claim 1 wherein the at least one projector setting comprises a horizontal dimension of a projected display.

4. The apparatus of claim 1 wherein the at least one projector setting comprises a vertical dimension of a projected display.

5. The apparatus of claim 1 wherein the at least one projector setting comprises a brightness of a projected display.

6. The apparatus of claim 1 wherein the at least one projector setting comprises a source of image data to be projected.

7. The apparatus of claim 1 wherein:
the projector comprises a variable angle scanning projector; and
the at least one projector setting comprises a horizontal scan angle.

8. The apparatus of claim 1 wherein:
the projector comprises a variable angle scanning projector; and
the at least one projector setting comprises a vertical scan angle.

9. The apparatus of claim 1 wherein at least one of the plurality of positional reference frames is defined by a location.

10. The apparatus of claim 1 wherein at least one of the plurality of positional reference frames is defined by an orientation.

11. The apparatus of claim 1 wherein at least one of the plurality of positional reference frames is defined by an elevation.

12. An apparatus comprising:
a scanning mirror assembly to scan light on a first axis and a second axis during operation;
a light source to provide the light to the scanning mirror assembly;
an actuating circuit to effect scanning of the scanning mirror assembly on at least one of the first axis and second axis, wherein the actuating circuit modifies a scan angle of the scanning mirror assembly during operation; and
a scan angle memorization component to memorize scan angle settings as a function of an orientation of the apparatus.

13. The apparatus of claim 12 further comprising an orientation sensor.

14. The apparatus of claim 12 further comprising a user interface to allow a user to specify the scan angle settings to be memorized.

15. An apparatus comprising:
a scanning mirror assembly to scan light on a first axis and a second axis during operation;
a light source to provide the light to the scanning mirror assembly;
an actuating circuit to effect scanning of the scanning mirror assembly on at least one of the first axis and second axis, wherein the actuating circuit modifies a scan angle of the scanning mirror assembly during operation; and
a scan angle memorization component to memorize scan angle settings as a function of a location of the apparatus.

16. The apparatus of claim 15 further comprising a location sensor.

17. The apparatus of claim 15 further comprising a user interface to allow a user to specify the scan angle settings to be memorized.

18. A method comprising:
presenting a user interface that allows a user to specify settings of a projected display;
sensing a positional reference frame; and
recording dimensions specified by the user and the positional reference frame.

19. The method of claim 18 wherein the positional reference frame is defined by a location.

20. The method of claim 18 wherein the positional reference frame is defined by an orientation.

21. The method of claim 18 wherein the positional reference frame is defined by an elevation.

22. The method of claim 18 wherein presenting a user interface that allows a user to specify dimensions of a projected display comprises presenting a user interface that allows a user to specify at least a scan angle of a scanning laser projector.

23. The method of claim 18 further comprising recalling the settings when the positional reference frame is again sensed.
